(19) United States
(12) Patent Application Publication
(10) Pub. No.: US 2023/0348692 A1
(43) Pub. Date: Nov. 2, 2023

(54) PLASTICIZED CELLULOSE ESTER COMPOSITIONS WITH IMPROVED MELT STRENGTH AND PROCESSABILITY AND FLOORING ARTICLES FORMED THEREFROM

(71) Applicant: Eastman Chemical Company, Kingsport, TN (US)

(72) Inventors: Robert Erik Young, Kingsport, TN (US); Michael Eugene Donelson, Kingsport, TN (US)

(73) Assignee: Eastman Chemical Company, Kingsport, TN (US)

(21) Appl. No.: 18/000,697

(22) PCT Filed: Jun. 3, 2021
(86) PCT No.: PCT/US2021/035595

§ 371 Date: Dec. 5, 2022

Related U.S. Application Data
(60) Provisional application No. 63/035,885, filed on Jun. 8, 2020.

(51) Int. Cl. C08K 5/103; C08K 3/34; C08K 3/36; C08J 5/18

(52) U.S. Cl. CPC C08K 5/103; C08K 3/346; C08K 3/36; C08J 5/18; C08K 2201/005; C08J 2301/14

(57) ABSTRACT

Disclosed is a plasticized cellulose ester composition. The plasticized cellulose ester composition of the present invention includes at least one cellulose ester; at least one plasticizer; and an effective amount of a melt- strength enhancing additive. Related calendered articles and flooring articles are also described.

### FIELD OF THE INVENTION

The present invention generally relates to plasticized cellulose ester compositions as well as articles formed from said compositions.

### BACKGROUND OF THE INVENTION

As the chemical industry and consumers look for environmentally friendly alternatives to certain chemicals, the growth of cellulose esters has increased significantly. Cellulose esters are plant-based compounds derived from cellulose, a polysaccharide found in wood, plants and plant products such as cotton. Cellulose esters have been used in a wide variety of consumer and industry end-product uses such as coatings and coating ingredients, objects such as eyeglass frames, disposable knives, forks, spoons, plates, cups and straws, toothbrush handles automotive trim, camera parts and disposable syringes. Cellulose esters also have intermediate and B2B product uses, often in the form of fibers, films, sheets and the like. Published studies indicate that the cellulose esters market is projected to grow from USD 9.27 billion in 2018 to USD 12.43 billion by 2023, at a CAGR of 6% from 2018 to 2023.

One end-use application of particular interest is so-called “resilient” flooring products that historically include vinyl sheet flooring, vinyl composite tile, luxury vinyl tile, rubber and linoleum. In this market, polyvinylchloride (PVC) has historically been utilized as a material; however, it has more recently has encountered lower popularity due to environmental concerns. WO2018/017652A1 and WO2018/089591A1, assigned to the assignee of the present invention, describe innovations which facilitate use of environmentally-friendly cellulose esters in various applications.

Despite the commercial growth of cellulose ester use, it is acknowledged in the art that challenges exist in utilizing cellulose esters in certain applications. For example, it is noted in U.S. Published Patent Application No. 2016/0068656 that, while cellulose esters are generally considered environmentally-friendly polymers and are derived from renewable sources like wood pulp, they have not been widely used in plastic compositions due to certain processing difficulties. The fact that production of film and sheet with cellulose esters has historically been limited to standard extrusion and solvent casting methods is also discussed in the above-referenced WO2018/017652A1, assigned to the assignee of the present invention.

An important characteristic for processability is composition melt strength. Melt strength can be described as the resistance of the composition melt to stretch or break under shear force and may be generally related to the molecular chain entanglements of the composition and its resistance to molecular chain untangling under strain. As chain entanglement and untangling resistance increase, melt strength may be improved at low shear rates. A quantitative indicator of melt strength is the complex viscosity of the composition in molten form at low (almost zero) shear, with higher complex viscosity at low shear correlating to higher melt strength, which in turn correlates to improved resistance to sagging during processing. This is particularly beneficial for formulations that use higher levels of fillers, as some fillers can cause increased sagging. In addition, the higher the melt strength, the easier it is to transfer the film from one roll to another and ultimately from the last roll on the calender.

Another characteristic known in the art to be generally relevant to and desirable for processability of a formulation or composition is referred to as “shear thinning”. Shear thinning is generally defined as a change in the viscosity of a fluid when placed under increasing shear strain forces, more particularly the decrease in complex viscosity of a given sample measured from lower shear rates to relatively higher shear rates. Compositions with advantageous levels of shear thinning characteristics can be processed more easily, with lower energy costs and reduced equipment wear, for example in mixing processes to blend and homogenize the composition and processes such as extrusion, injection molding, calendering and the like for forming the composition into useful articles such as films or sheets. Many PVC materials used in flooring, particularly in conjunction with flooring articles or components formed via calendering, typically inherently shear thin during processing. Shear thinning is therefore particularly relevant in the pursuit of compositional alternatives for polyvinylchloride in the resilient flooring market.

Though maximum melt strength is important to processability, it must be carefully balanced with maintaining a composition's decrease in viscosity from shear thinning. Accordingly, compositions useful as PVC alternatives in resilient flooring articles and in particular multilayer resilient flooring articles must exhibit desirably high melt strength while also exhibiting sufficient shear-thinning to be processable (e.g. via extrusion or calendering) into end-use forms such as films or layers. Despite advances in the technology, a continuing unmet need remains for compositions useful in flooring applications that employ environmentally-friendly materials while exhibiting processing and performance characteristics comparable to if not exceeding that of polyvinylchloride flooring.

### SUMMARY OF THE INVENTION

In a first aspect, the present invention relates to a plasticized cellulose ester composition. The plasticized cellulose ester composition of the present invention includes at least one cellulose ester; at least one plasticizer; and an effective amount of melt strength-enhancing additive.

In another aspect, the present invention relates to a calendered article. The calendered article of the present invention is formed from a plasticized cellulose ester composition that includes at least one cellulose ester; at least one plasticizer; and an effective amount of melt strength-enhancing additive.

In yet another aspect, the present invention is directed to a flooring article. The flooring article of the present invention includes at least one layer of a plasticized cellulose ester composition of the present invention that includes at least one cellulose ester; at least one plasticizer; and an effective amount of melt strength-enhancing additive.

Further aspects of the invention are as disclosed and claimed herein.

### BRIEF DESCRIPTION OF THE DRAWINGS

FIG. 1 is a side elevational view of an embodiment of a multilayer resilient flooring article of the present invention.

### DETAILED DESCRIPTION

For avoidance of doubt, it is expressly provided for that the information and descriptions herein regarding features or elements of one aspect of the present invention are expressly asserted as applicable to and are relied on to also support those features and elements when described with regard to all other aspects of the invention.

In a first aspect, the present invention is directed to a plasticized cellulose ester composition. The plasticized cellulose ester composition of this aspect of the present invention includes at least one cellulose ester; at least one plasticizer; and an effective amount of melt strength-enhancing additive. In one or more embodiments, the melt strength-enhancing additive is selected from the group consisting of clay, silica, talc and combinations thereof.

The plasticized cellulose ester composition of the present invention includes at least one cellulose ester. A cellulose ester is generally defined to include cellulose esters of one or more carboxylic acids and are described for example in U.S. Pat. No. 5,929,229, assigned to the assignee of the present invention, the contents and disclosure of which are incorporated herein by reference. Non limiting examples of cellulose esters include cellulose acetate, cellulose propionate, cellulose butyrate, so-called mixed acid esters such as cellulose acetate propionate and cellulose acetate, and combinations thereof. In one or more embodiments, the at least one cellulose ester is chosen from cellulose acetate, cellulose acetate propionate, or cellulose acetate butyrate and combinations thereof. In one or more embodiments, the cellulose ester is cellulose acetate. In one or more embodiments, the at least one cellulose ester is cellulose acetate propionate. In one or more embodiments, the at least one cellulose ester is cellulose acetate butyrate. In one or more embodiments, the at least one cellulose ester is a combination of cellulose acetate propionate and cellulose acetate butyrate.

In one or more embodiments, the amount of cellulose ester in the plasticized cellulose ester composition is between 25% and 99% by weight, or between 35% and 99%, or between 45% and 99%, all based on the total weight of the plasticized cellulose ester composition.

The cellulose ester of the present invention may be characterized using one or more characteristics. For example, in one or more embodiments, the cellulose ester may have a number average molecular weight (“Mn”) that is in the range of from 20,000 Da to 100,000 Da. In one or more embodiments, the cellulose ester has a Mn that is in the range of from about 20,000 Da to about 80,000 Da.

The cellulose ester may have in one or more embodiments a solution ball-drop viscosity of 2 to 30 or 4 to 25 or 5 to 20 seconds as measured by ASTM D817.

The cellulose ester may have in one or more embodiments one or more of a hydroxyl degree of substitution (DSOH) of from 0.1 to 0.8; an acetyl degree of substitution of from of from 0.1 to 0.8; a propionyl degree of substitution (DSPR) of from 1.4 to 2.8; or alternative to the propionyl , a butyryl degree of substitution (DSBU) of from 1.4 to 2.8. By way of brief background, DSOH, DSAC, DSPR and DSBU are measures of the degree of esterification for a given cellulose ester. Cellulose has three hydroxyls per anhydroglucose unit, located at the C2, C3 and C6 carbons, that can be esterified to varying degrees and in different ratios with various acyl groups, with the specific type of cellulose ester formed depending on the functionalization of the hydroxyl groups. Cellulose acetate propionate of this invention may have a DSAC of approximately 0.2, a DSPR of approximately 2.5 and a DSOH of approximately 0.3. Cellulose acetate butyrate of the present invention may have a DSAC of approximately 1.0, a DSBU of approximately 1.7 and a DSOH of approximately 0.3.

The cellulose ester may in one or more embodiments have a glass transition temperature (Tg) of 50° C. to 150° C. or from 70° C. to 120° C. or no more than 160° C.

The cellulose ester may in one or more embodiments have a percent crystallinity of less than 20% or less than 15% or less than 10% or less than 5% or from 5% to 10% or from 5% to 15% or from 5% to 20% or from 10% to about 20%. Crystallinity is described herein using and measured in the context of the present invention from, the second heat cycle in accordance with ASTM D3418 and assuming an enthalpy of melting of 14 cal/g for the cellulose esters. In this method, the amount of crystallinity is measured under a prescribed heating history, more particularly the “2^{nd} cycle” cooling and heating in a differential scanning calorimeter (DSC) per ASTM D3418. In this method, the sample is first heated in the DSC to above its melting temperature to erase any prior crystallinity (i.e. the “first heat cycle”). Next the sample is cooled at 20 degrees C. per minute to below Tg, and then reheated at the same rate to above the melting temperature again (the “2^{nd} heat cycle”). During this cooling and 2^{nd} heating, the material will recrystallize to a certain degree, and this amount of crystallization is measured in the scan as the enthalpy of melting at the melting temperature.

The plasticized cellulose ester composition of the present invention further includes at least one plasticizer. In one or more embodiments, the plasticized cellulose ester composition includes from 5% to 35% by weight or from 10% to 30% by weight of said plasticizer based on the total weight of said composition.

The plasticizer may be any plasticizer known in the art useful for plasticizing cellulose esters, including for example aromatic phosphate ester plasticizer, alkyl phosphate ester plasticizer, dialkylated diester plasticizer, tricarboxylic ester plasticizer, polymeric polyester plasticizer, polyglycol diester plasticizer, polyester resin plasticizer, aromatic diester plasticizer, aromatic triester plasticizer, aliphatic diester plasticizer, carbonate plasticizer, epoxidized ester plasticizer, epoxidized oil plasticizer, benzoate plasticizer, polyol benzoate plasticizer adipate plasticizer, a phthalate plasticizer, a glycolic acid ester plasticizer, citric acid ester plasticizer, hydroxyl-functional plasticizer, solid, non-crystalline resin plasticizer or combinations thereof. In one or more embodiments, the plasticizer is chosen from the group consisting of triethylene glycol 2-ethyl hexanoate, epoxidized soybean oil, acetyl triethyl citrate and combinations thereof.

The plasticized cellulose ester composition of the present invention further includes a melt strength-enhancing additive. As discussed elsewhere herein, melt strength can be described as the resistance of a composition melt to stretching or breaking under shear force and may be generally related to the molecular chain entanglements of the composition and its resistance to molecular chain untangling under strain. Melt strength may be quantified for example by measuring the complex viscosity of a composition at low, almost no shear. Similarly, improvements or enhancements to melt strength may be quantified for example by measuring the complex viscosity difference between a control and a sample at low shear, almost no shear. For purposes for this application, melt strength enhancement means an increase in complex melt viscosity of a plasticized cellulose ester composition with a melt strength-enhancing additive versus a control plasticized cellulose ester composition of the same composition but without the melt strength-enhancing additive when measuring complex viscosity of the compositions as described herein at 1 sec⁻¹.

Melt strength-enhancing additives include additives that, when included in a plasticized cellulose ester composition in an effective amount, increase the complex viscosity of the composition as compared to a control of the same composition but without the melt strength-enhancing additive. In one or more embodiments, the plasticized cellulose ester composition of the present invention includes an effective amount of melt strength-enhancing additive wherein an “effective amount” means that the composition may be characterized by complex melt viscosity higher than a control plasticized cellulose ester composition of the same composition but without the melt strength-enhancing additive.

In one or more embodiments, the melt strength-enhancing additive may be selected from the group consisting of clay, silica, talc and combinations thereof. In one or more embodiments, the melt strength-enhancing additive may be selected from the group consisting of clay, silica and combinations thereof. In one or more embodiments, the clay has a particle size of from 1-60 microns, a density of 1.5-2.2 g/cm³, and a bulk density of less than 500 g/cm³. In one or more embodiments, the amount of melt strength-enhancing additive is from 0.25% to 10.0% by weight or from 0.25% to 8.0% based on the total weight of the plasticized cellulose ester composition.

Non-limiting examples of clays suitable as a melt strength-enhancing additive in the plasticized cellulose ester composition of the present invention include without limitation natural, treated and modified bentonites; natural, treated and modified silicates, natural, treated and modified phyllosilicates; kaolinite, montmorillonite, bentonite, laponite, taramite, corresponding salts and combinations thereof. Suitable clays are commercially available and include without limitation clays available from BYK, a division of ALTANA, under the trade names BYK-MAXI™, Cloisite™, Garamite™, Claytone™ and Laponite™; and clay available from Nancor under the trade name Nanocor™ L34TCN. Additionally, one borax decahydrate was evaluated from US Borax.

Examples of silicas suitable as a melt strength-enhancing additive in the plasticized cellulose ester compositions of the present invention include without limitation silicas, fumed silicas, hydrophobic silicas, precipitated silicas, amorphous silicas, microcrystalline silicas and other treated silicas. Suitable silicas are commercially available for example from Evonik under the trade names Aerosil™ R9200 and Aerosil™ R972.

The composition of the present invention may further include one or more of processing aids, impact modifiers and roll release agents. In one or more embodiments, the plasticized cellulose ester composition of the present invention may include at least one roll release agent. Suitable roll release agents are known in the art and are described for example in U.S. Pat. No. 6,551,688, the contents and disclosure of which are incorporated herein by reference. Examples of suitable roll release agents include without limitation lubricants, exemplified by waxes such as amide waxes, fatty acids, fatty acid esters, fatty acid salts, saponified fatty acid salts and combinations thereof. Examples of a fatty acid esters include esters of montanic acid. In one or more embodiments, the roll release agent is a fatty acid ester selected from the group consisting of butylene glycol ester of montanic acid, glycerol ester of montanic acid, pentaerythritol ester of montanic acid and combinations thereof.

When roll release agents are included in the present invention, they are typically present in an amount of about 0.1% to about 2.0% roll release agent by weight based on the total weight of the composition. In one or more embodiments, the composition of the present invention includes 0.1% to 1.0% by weight roll release agent based on the total weight of the composition. In one or more embodiments, the composition of the present invention includes 0.1% to 0.5% by weight roll release agent based on the total weight of the composition. In one or more embodiments, the composition of the present invention includes 0.5% to 1.0% by weight roll release agent based on the total weight of the composition. In one or more embodiments, the composition of the present invention includes 1.0% to 2.0% by weight roll release agent based on the total weight of the composition. In one or more embodiments, the composition of the present invention includes 1.5% to 2.0% by weight roll release agent based on the total weight of the composition.

The present invention may further include at least one processing aid. Processing aids may for example improve the texture and “fusion” of the melt, improve melt strength, reduce composition melting time, reduce overall processing time and help with metal release from calendering rolls. Processing aids are known in the art and may be derived for example from acrylics, and acrylic copolymers although processing aids based on styrenics, carbonates, polyesters, other olefins, siloxanes, and combinations thereof, and are known and commercially available. Suitable processing aids are commercially available and include without limitation Paraloid™ K-125 available from Dow; Kane-Ace® PA-20, PA-610, B622, MR01 and MP90 available from Kaneka Corporation; and Ecdel™ available from Eastman Chemical Company. In one or more embodiments, the processing aid includes one or more of acrylic polymer, an acrylic copolymer, a styrenic polymer, a carbonate polymer, a polyester polymer, an olefin polymer and a siloxane polymer. In one or more embodiments, the processing aid is selected from the group consisting of an acrylic polymer, an acrylic copolymer and combinations thereof. In one embodiment, the processing aid comprises an acrylic processing aid, more particularly a Kane-Ace® acrylic processing aid.

The amount of processing aid present in the present invention may vary depending on, the type of processing aid and its molecular weight and viscosity, the other components of the composition and the composition's end-use application. When processing aids are included in the present invention, they are typically present in an amount of 0% to about 3.0% by weight processing aid based on the total weight of the composition. In one or more embodiments, the composition of the present invention includes 0.1% to 6.0% by weight processing aid based on the total weight of the composition. In one or more embodiments, the composition of the present invention includes 0.5% to 6.0% by weight processing aid based on the total weight of the composition. In one or more embodiments, the composition of the present invention includes 0.5% to 3.0% by weight processing aid based on the total weight of the composition.

The present invention may also include at least one impact modifier. Examples of impact modifiers include core-shell polymers based on acrylics, including acrylic polymers, methacrylate butadiene styrene (MBS) polymers, silicone-acrylic polymers and combinations thereof. Other suitable impact modifiers include acrylonitrile-butadiene styrene (ABS), ethylene vinyl acetate copolymers, chlorinated polyethylenes, ethylene copolymers and combinations thereof. Impact modifier, if present, is typically present in the composition of the present invention in an amount of 1% to about 20% by weight impact modifier based on the total weight of the composition.

The composition of the present invention may further include one or more other ingredients or components such as for example other polymers such as acrylics; fillers such as calcium carbonate, talc, glass beads and glass fibers; flame retardants, lubricants, pigments, dispersing aids, biocides, antistatic agents, water repelling additives, rodenticides, dyes, colorants and the like.

An important feature of the plasticized cellulose ester composition of the present invention is its surprising improvement in melt strength as demonstrated by its unexpectedly higher complex viscosity when compared to a control. In general, the absolute level of low-shear viscosity can dictate the temperature required to process a sample. To demonstrate the surprising melt strength characteristics of the plasticized cellulose ester compositions of the present invention, Applicants herein compare the complex viscosity in Poise for the compositions of the present invention, measured at a shear rate of 1 sec⁻¹, to a control resin, which compositionally matches the inventive cellulose ester compositions with the exception of the presence of a melt-strength-enhancing additive. A quantitative calculation for this comparison can be Melt Strength Enhancement, or “MSE”, which may be calculated according to the following equation:

MSE (%)=[(V1−V2)/V2]×100

wherein V1 is the complex viscosity in Poise at a shear rate of 1 sec⁻¹ for an inventive composition (such compositions shown as Formulations and Samples 1-12 and 14 in the Tables below) and V2 is the complex viscosity in Poise at a shear rate of 1 sec⁻¹ for a the control composition (shown as Formulation and Sample 13 in the Tables below). A positive MSE (%) indicates the material has improved melt strength and is for example more resistant to sagging during processing versus control. The shear rate may be measured according to ASTM D-4440 at a temperature of 185° C. In one or more embodiments, the plasticized cellulose ester compositions of the present invention exhibit an MSE of at least 20% or at least 50% or at least 80%.

Another important feature of the plasticized cellulose ester composition of the present invention is its unexpected level of shear thinning at elevated melt strengths. Shear-thinning is a characteristic of fluids such as compositions and formulations in which the fluid's complex viscosity decreases as the fluid is subjected to increasing shear rate forces. As mentioned above, shear thinning is the change in complex viscosity of a given sample from lower shear rates to relatively higher shear rates. It is possible to quantify shear thinning by comparing a composition's complex viscosity at a relatively low shear rate to its complex viscosity at a relatively higher shear rate. To demonstrate the surprising shear-thinning characteristics of the plasticized cellulose ester compositions of the present invention, Applicants herein compare the complex viscosity in Poise at a shear rate of 1 sec⁻¹ to the complex viscosity in Poise at a shear rate of 400 sec⁻¹ to determine a Total Complex Viscosity Reduction (TCVR) according to the following equation:

TCVR (%)=[(V1−V2)/V1]×100

wherein V₁ is the complex viscosity in Poise of the composition at a shear rate of 1 sec⁻¹ and V₂ is the complex viscosity of the composition at a shear rate of 400 sec⁻¹. The shear rate may be measured according to ASTM D-4440 at a temperature of 185° C. Higher TCVR values are indicative of a higher level of shear-thinning. In one or more embodiments, the plasticized cellulose ester composition of the present invention exhibits a total complex viscosity reduction (TCVR) of at least 90% or at least 92% or at least 93% or at least 94% or at least 95%.

In one or more embodiments, the plasticized cellulose ester composition of the present invention exhibits a melt strength enhancement (MSE) of at least 20% or at least 50% or at least 80% and a total complex viscosity reduction (TCVR) of at least 90% or at least 92% or at least 93% or at least 94% or at least 95%.

In one or more embodiments, the plasticized cellulose ester composition of the present invention is suitable for or capable of forming a calendered article such as for example a sheet or film. Accordingly, in an aspect, the present invention relates to a calendered article comprising or formed from a plasticized cellulose ester composition that includes at least one cellulose ester; at least one plasticizer; and an effective amount of a melt strength-enhancing additive. In one or more embodiments, the melt strength-enhancing additive is selected from the group consisting of clay, silica and combinations thereof. As previously noted, information and descriptions set forth herein in regard to features and elements of the plasticized cellulose ester composition aspect of the present invention or other aspects are intended to be applicable to and fully support this calendered article aspect or other aspects.

By use of the phrase “calendered article” the present invention intends to describe articles such as films or sheets formed using a calendering method with a molten polymer wherein the molten polymer is forced through the nips of counterrotating rolls to form a film or sheet and gradually squeezed down to a film or sheet of final thickness by optionally passing through additional rolls having a similar counterrotating arrangement (with the roll arrangements typically referred to as a “stack”). The film or sheet may be subjected to additional treatment, such as for example stretching, annealing, slitting or the like, with the final article then wound on a winder. Calendering and calendered articles as used herein are described in more detail in U.S. Published Patent Application No. 2019/0256674, assigned to the assignee of the present invention, the contents and disclosure of which are incorporated herein by reference.

In one or more of these embodiments, the plasticized cellulose ester composition has a melt viscosity according to ASTM 3835 of 1000 Poise to 5000 Poise or 2000 Poise to 5000 Poise at a temperature of 190° C. and a shear rate of 628 s⁻¹. In one or more of these embodiments, the plasticized cellulose ester composition of the present invention is capable of being calendered at the temperature range of the sum of the glass transition temperature of the cellulose ester of the composition plus 20° C. to the sum of the glass transition temperature of the cellulose ester of the composition plus 100° C. With a view toward these embodiments, an aspect of the present invention is a calendered article formed from the plasticized cellulose ester composition of the present invention, particularly wherein the calendered article is a film or sheet and more particularly wherein the calendered article is a sheet or film that useful as of that forms a layer of a multilayer resilient flooring article.

Though the preceding aspect of the present invention describes a utility of the plasticized cellulose ester composition of the present invention in the field of calendering and calendered articles, one of ordinary skill in the art will appreciate that the composition of the present invention may also be useful in forming articles by other known methods, such as for example extrusion, injection molding, blow-molding, additive manufacturing (3D printing), profile extrusion, blown film, multilayer film, sheet lamination and the like.

The plasticized cellulose ester composition of the present invention may be useful in forming a flooring article, a calendered flooring article or more particularly a layer of a flooring article or a calendered layer of a flooring article. Accordingly, in another aspect, the present invention is directed to a flooring article. The flooring article of this aspect of the present invention includes at least one layer. In one or more embodiments, the at least one layer is a calendered layer. In one or more embodiments, the at least one layer is formed from the plasticized cellulose ester composition of the present invention. Accordingly, the at least one layer includes a plasticized cellulose ester composition that includes at least one cellulose ester; at least one plasticizer; and an effective amount of a melt strength-enhancing additive. In one or more embodiments, the melt strength-enhancing additive is selected from the group consisting of clay, silica and combinations thereof. Flooring articles contemplated as within the scope of present invention include without limitation any material or construction intended for use as, installation on or application to a walking surface or lower surface of a room or building. Non-limiting examples of flooring articles include rolled flooring, squares, tiles, planks, sheet, laminates and the like which may be installed for example as a so-called “floating” floor or a glued-down floor assembly. As previously noted, information and description set forth in regard to features and elements of the plasticized cellulose ester composition aspect or other aspects of the present invention are applicable to and intended to fully support all other aspects including this aspect directed to flooring articles.

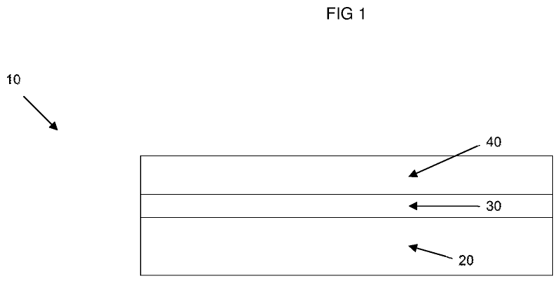

In one or more embodiments, the flooring article is a resilient flooring article. In one or more embodiments, the resilient flooring article is a multilayer resilient flooring article or a laminated flooring article. In a non-limiting exemplary embodiment of a multilayer resilient flooring article depicted in FIG. 1, the multilayer resilient flooring article 10 of the present invention includes a core layer 20 and a top layer 40. The multilayer resilient flooring article may also include an optional print layer 30 between the core layer 20 and the top layer 40. The top or wear layer 40 provides scratch and abrasion resistance while also allowing for visibility through the top surface of any underlying print layer design and typically has a thickness of between 15 mils and 25 mils. The base or core layer 20 provides dimensional stability and typically has a thickness of a thickness of at least 75 mils. The print layer 30 may provide a visual color and/or design, for example in the form of geometric patterns or images, and typically has a thickness of between 3 mils and 5 mils.

As discussed elsewhere herein, the core layer 20, top layer 40 and print layer 30 may each be a calendered sheet or a calendered film. Other optional layers, such as removable backing layers, adhesive layers and the like, may also be included. Multilayer resilient flooring articles on the type contemplated herein are generally known in the art and are described for example in U.S. Pat. No. 8,071,193, the contents and disclosure of which are incorporated herein by reference.

In one or more embodiments, the flooring article of the present invention may be a multilayer resilient flooring article that includes at least one layer of the plasticized cellulose ester composition of the present invention. In one or more embodiments, the at least one layer is a calendered layer or a calendered sheet or a calendered film. In one or more embodiments, the flooring article of the present invention may be a multilayer resilient flooring article that includes a core layer of the plasticized cellulose ester composition of the present invention. In one or more embodiments wherein the multilayer resilient flooring article includes a print layer, the flooring article of the present invention may be a multilayer resilient flooring article that includes a print layer of the plasticized cellulose ester composition of the present invention. In one or more embodiments, the flooring article is a multilayer resilient flooring article comprising a wear layer, a core layer and a print layer with the flooring article comprising a core layer and a print layer both of the plasticized cellulose ester composition of present invention. In one or more embodiments, the core layer or the print layer exhibits a haze value of more than 10% or more than 20% or more than 30% or more than 40% when measured in accordance with ASTM D1003 at an article thickness of 60 mils or greater.

### Specific Embodiments

Embodiment 1. A plasticized cellulose ester composition, said composition comprising at least one cellulose ester; at least one plasticizer; and an effective amount of a melt strength-enhancing additive selected from the group consisting of clay, silica and combinations thereof. Embodiment 2. The composition of Embodiment 1 wherein said composition comprises from 5% to 35% by weight of plasticizer based on the total weight of said composition. Embodiment 3. The composition of Embodiment 2 wherein said composition comprises from 10% to 30% by weight of plasticizer based on the total weight of said composition. Embodiment 4. The composition of any one of Embodiments 1-3 wherein said plasticizer is selected from the group consisting of triethylene glycol 2-ethyl hexanoate, dioctyl adipate, di-n-hexyl azelate, epoxidized soybean oil, acetyl triethyl citrate and combinations thereof. Embodiment 5. The composition of any one of Embodiment 1-4 wherein said amount of said melt-strength-enhancing additive is from 0.25% to 8.0% by weight based on the total weight of said composition. Embodiment 6. The composition of any one of Embodiments 1-5, wherein the clay, wherein the clay has a particle size of from 1-60 microns, a density of 1.5-2.2 g/cm³, and a bulk density of less than 500 g/cm³. Embodiment 7. The composition of any one of Embodiments 1-6 wherein said composition further comprises one or more of roll release agents, processing aids, impact modifiers, fillers such as calcium carbonate, flame retardants, lubricants, pigments, dispersing aids, biocides, antistatic agents, water repelling additives, rodenticides, dyes and colorants. Embodiment 8. The composition of any one of Embodiments 1-7 wherein said at least one cellulose ester is selected from the group consisting of cellulose acetate propionate, cellulose acetate butyrate and combinations thereof. Embodiment 9. The composition of Embodiment 8 wherein said at least one cellulose ester is cellulose acetate propionate. Embodiment 10. The composition of any one of Embodiments 1-9 wherein said composition exhibits a melt strength enhancement (MSE) of at least 20%. Embodiment 11. A flooring article comprising at least one layer of the plasticized cellulose ester composition of any one of Embodiments 1-10. Embodiment 12. A multilayer resilient flooring article that includes a core layer of the plasticized cellulose ester composition of any one of Embodiment 1-10. Embodiment 13. A calendered article formed from the composition of any one of Embodiments 1-10. Embodiment 14. The calendered article of Embodiment 13 wherein said calendered article is a sheet or film. Embodiment 15. The calendered article of Embodiment 14 wherein said sheet or film is suitable for use as a layer of a multilayer resilient flooring article. Embodiment 16. The plasticized cellulose ester composition of any one of Embodiments 1-10 wherein said plasticized cellulose ester composition exhibits a total complex viscosity reduction (TCVR) of at least 90%.

The following examples, while provided to illustrate with specificity and detail the many aspects and advantages of the present invention, are not be interpreted as in any way limiting its scope. Variations, modifications and adaptations which do depart from the spirit of the present invention will be readily appreciated by one of ordinary skill in the art.

### Sample Preparation

To demonstrate the present invention, 3 samples of the inventive plasticized cellulose ester composition were formulated to include a cellulose ester, a plasticizer and a melt strength-enhancing additive selected from the group consisting of clay, silica and combinations thereof. Two control compositions were also prepared in which the melt strength enhancing/shear thinning additive was omitted. Details regarding each inventive composition as well as the control are set forth in Table 1 below. The control identified as sample 13 is for inventive compositions identified as samples 1-12 and 14, Additionally, sample 15 is identified as the control for inventive compositions 16-25.

TABLE 1

| | Formulation Number and Weight Percent | | | | | | | | |
|---|---|---|---|---|---|---|---|---|---|
| Ingredient | 1 | 2 | 3 | 4 | 5 | 6 | 7 | 8 | 9 |
| CAP 482-20 | 72.0 | 72.0 | 72.0 | 72.0 | 72.0 | 72.0 | 72.0 | 72.0 | 72.0 |
| TEG2EH | 22.0 | 22.0 | 22.0 | 22.0 | 22.0 | 22.0 | 22.0 | 22.0 | 22.0 |
| Kaneka PA 20 | 2.0 | 2.0 | 2.0 | 2.0 | 2.0 | 2.0 | 2.0 | 2.0 | 2.0 |
| Licowax OP | 1.0 | 1.0 | 1.0 | 1.0 | 1.0 | 1.0 | 1.0 | 1.0 | 1.0 |
| Cloisite 20 | 3.0 | 0 | 0 | 0 | 0 | 0 | 0 | 0 | 0 |
| Cloisite 11B | 0 | 3.0 | 0 | 0 | 0 | 0 | 0 | 0 | 0 |
| Cloisite CA++ | 0 | 0 | 3.0 | 0 | 0 | 0 | 0 | 0 | 0 |
| Cloisite NA | 0 | 0 | 0 | 3.0 | 0 | 0 | 0 | 0 | 0 |
| Garamite 7305 | 0 | 0 | 0 | 0 | 3.0 | 0 | 0 | 0 | 0 |
| Nanocor L34TCN | 0 | 0 | 0 | 0 | 0 | 3.0 | 0 | 0 | 0 |
| Claytone APA | 0 | 0 | 0 | 0 | 0 | 0 | 3.0 | 0 | 0 |
| Cloisite 93A | 0 | 0 | 0 | 0 | 0 | 0 | 0 | 3.0 | 0 |
| Garamite 1958 | 0 | 0 | 0 | 0 | 0 | 0 | 0 | 0 | 3.0 |
| Laponite RD | 0 | 0 | 0 | 0 | 0 | 0 | 0 | 0 | 0 |
| Aerosil R9200 | 0 | 0 | 0 | 0 | 0 | 0 | 0 | 0 | 0 |
| Aerosil R972 | 0 | 0 | 0 | 0 | 0 | 0 | 0 | 0 | 0 |
| BYK Max 4255 | 0 | 0 | 0 | 0 | 0 | 0 | 0 | 0 | 0 |
| Claytone VZ | 0 | 0 | 0 | 0 | 0 | 0 | 0 | 0 | 0 |
| Claytone MPZ | 0 | 0 | 0 | 0 | 0 | 0 | 0 | 0 | 0 |
| Claytone APA | 0 | 0 | 0 | 0 | 0 | 0 | 0 | 0 | 0 |

| | Formulation Number and Weight Percent | | | | | | | |
|---|---|---|---|---|---|---|---|---|
| | | | | 13 | | 15 | | |
| Ingredient | 10 | 11 | 12 | (control) | 14 | (control) | 16 | 17 |
| CAP 482-20 | 72.0 | 72.0 | 73.5 | 75.0 | 72.0 | 75.0 | 71.0 | 73.0 |
| TEG2EH | 22.0 | 22.0 | 22.0 | 22.0 | 22.0 | 22.0 | 22.0 | 22.0 |
| Kaneka PA 20 | 2.0 | 2.0 | 2.0 | 2.0 | 2.0 | 2.0 | 2.0 | 2.0 |
| Licowax OP | 1.0 | 1.0 | 1.0 | 1.0 | 1.0 | 1.0 | 1.0 | 1.0 |
| Cloisite 20 | 0 | 0 | 0 | 0 | 0 | 0 | 0 | 0 |
| Cloisite 11B | 0 | 0 | 0 | 0 | 0 | 0 | 4.0 | 2.0 |
| Cloisite CA++ | 0 | 0 | 0 | 0 | 0 | 0 | 0 | 0 |
| Cloisite NA | 0 | 0 | 0 | 0 | 0 | 0 | 0 | 0 |
| Garamite 7305 | 0 | 0 | 0 | 0 | 0 | 0 | 0 | 0 |
| Nanocor L34TCN | 0 | 0 | 0 | 0 | 0 | 0 | 0 | 0 |
| Claytone APA | 0 | 0 | 0 | 0 | 0 | 0 | 0 | 0 |
| Cloisite 93A | 0 | 0 | 0 | 0 | 0 | 0 | 0 | 0 |
| Garamite 1958 | 0 | 0 | 0 | 0 | 0 | 0 | 0 | 0 |
| Borax Decahydrate | | | 1.5 | | | | | |
| Laponite RD | 3.0 | 0 | 0 | 0 | 0 | 0 | 0 | 0 |
| Aerosil R9200 | 0 | 0 | 0 | 0 | 3.0 | 0 | 0 | 0 |
| Aerosil R972 | 0 | 3.0 | 0 | 0 | 0 | 0 | 0 | 0 |
| BYK Max 4255 | 0 | 0 | 0 | 0 | 0 | 0 | 0 | 0 |
| Claytone VZ | 0 | 0 | 0 | 0 | 0 | 0 | 0 | 0 |
| Claytone MPZ | 0 | 0 | 0 | 0 | 0 | 0 | 0 | 0 |
| Claytone APA | 0 | 0 | 0 | 0 | 0 | 0 | 0 | 0 |

Formulation Number and Weight Percent

| Ingredient | 18 | 19 | 20 | 21 | 22 | 23 | 24 | 25 |
|---|---|---|---|---|---|---|---|---|
| CAP 482-20 | 71.0 | 73.0 | 71.0 | 75.0 | 73.0 | 71.0 | 73.0 | 71.0 |
| TEG2EH | 22.0 | 22.0 | 22.0 | 22.0 | 22.0 | 22.0 | 22.0 | 22.0 |
| Kaneka PA 20 | 2.0 | 2.0 | 2.0 | 2.0 | 2.0 | 2.0 | 2.0 | 2.0 |
| Licowax OP | 1.0 | 1.0 | 1.0 | 1.0 | 1.0 | 1.0 | 1.0 | 1.0 |
| Cloisite 11B | 0 | 0 | 0 | 0 | 0 | 0 | 0 | 0 |
| BYK-Max CT | 4.0 | 2.0 | 0 | 0 | 0 | 0 | 0 | 0 |
| 4255 | | | | | | | | |
| Claytone VZ | 0 | 0 | 4.0 | 0 | 2.0 | 0 | 0 | 0 |
| Claytone MPZ | 0 | 0 | 0 | 0 | 0 | 4.0 | 2.0 | 0 |
| Claytone APA | 0 | 0 | 0 | 0 | 0 | 0 | 0 | 4.0 |

With regard to the components listed in Table 1: CAP 482-20 is a high viscosity Cellulose Acetate Propionate available from Eastman Chemical Company with a solution ball-drop viscosity of 20 seconds as measured by ASTM D817. PA20™ is a Kane-Ace® medium molecular weight process aid available from Kaneka. Licowax™ OP is a wax, more particularly a partially saponified calcium salt of montanic acids and is available from Clariant Corporation. Triethylene glycol bis (2-EthylHexanoate) (TEGEH) is a plasticizer available from Eastman Chemical Company. Cloisite™ 20, Cloisite™ 11B, Cloisite™ CA++, Cloisite™ NA, Garamite™ 7305, Garamite™ 1958, Laponite™ RD, Claytone™ APA and Cloisite™ 93A, BYK-MAX CT4255, CLAYTONE-MPZ, CLAYTONE-VZ are all clays available from BYK, a division of ALTANA. Nanocor™ L34TCN is a clay available from Nancor. Aerosil™ R9200 and Aerosil™ R972 are silicas available from Evonik.

To form each of the formulations, ingredients were weighed at the percentages indicated in Table 1 on Toledo-Mettler top loading balance to a total mass of 150 grams, placed in a polyethylene bag and then shaken until the powdered mixture visually appeared to be uniform. Samples were then 20 placed on a Dr. Collin Two Roll Mill with the front-roll temperature set at 170° C., the back-roll temperature set at 165° C. and the roll speed set at 10 rpm. The time from when the powdered mixture was placed on the mill to when it achieved a plastic form was recorded as a general indicator of processability. To further demonstrate processability into a film, the resulting plastic material was then removed from the mill as a continuous film of 0.010″ (250 microns) thickness and allowed to cool.

### Analytical Methods

Each of the samples prepared above and listed in the Table 1 were tested for complex viscosity (in Poise) according to ASTM D-4440 at shear rates starting at 1 sec⁻¹ and then at increasing shear rates to a shear rate of 400 sec⁻¹. Test temperature was held constant at 185° C. Samples were pre-dried in a vacuum oven for 2 days at 60° C. The results of the complex viscosity testing are set forth in Table 2 below. TCVR and MSE values for each sample were calculated according to the equations set forth herein and are set forth in Table 3 below.

TABLE 2
Viscosity vs Shear Rate (poise)

| Shear | | | | | | | | | | | | | |
|---|---|---|---|---|---|---|---|---|---|---|---|---|---|
| Rate | <−Sample number−> | | | | | | | | | | | | |
| (1/s) | 1 | 2 | 3 | 4 | 5 | 6 | 7 | 8 | 9 | 10 | 11 | 12 | 13 |
| 1.0 | 39277 | 78868 | 29843 | 26671 | 47383 | 43694 | 54404 | 73122 | 45563 | 32874 | 38120 | 33643 | 25252 |
| 1.6 | 33739 | 61181 | 26562 | 24148 | 39544 | 37486 | 45383 | 57718 | 38321 | 29126 | 33675 | 30771 | 22528 |
| 2.5 | 28841 | 48500 | 23288 | 21365 | 33195 | 32104 | 37862 | 46471 | 32103 | 25650 | 28819 | 27587 | 20009 |
| 4.0 | 24358 | 38248 | 20172 | 18682 | 27595 | 27124 | 31251 | 37150 | 26761 | 22188 | 24421 | 24074 | 17460 |
| 6.3 | 20512 | 30515 | 17375 | 16243 | 22903 | 22761 | 25841 | 30013 | 22190 | 19054 | 20596 | 20737 | 15121 |
| 10.0 | 17186 | 24276 | 14803 | 13968 | 18942 | 18978 | 21158 | 24148 | 18298 | 16212 | 17241 | 17590 | 12932 |
| 15.8 | 14194 | 19258 | 12476 | 11879 | 15472 | 15589 | 17137 | 19332 | 14883 | 13531 | 14211 | 14596 | 10944 |
| 25.1 | 11560 | 15193 | 10310 | 9901 | 12482 | 12629 | 13721 | 15352 | 11957 | 11093 | 11538 | 11868 | 9077 |
| 39.8 | 9273 | 11878 | 8383 | 8113 | 9939 | 10082 | 10837 | 12048 | 9479 | 8944 | 9231 | 9469 | 7396 |
| 63.1 | 7332 | 9200 | 6704 | 6536 | 7811 | 7937 | 8454 | 9350 | 7416 | 7095 | 7272 | 7414 | 5925 |
| 100.0 | 5714 | 7015 | 5274 | 5176 | 6054 | 6156 | 6480 | 7135 | 5721 | 5538 | 5640 | 5711 | 4664 |
| 158.5 | 4375 | 5317 | 4083 | 4034 | 4610 | 4691 | 4928 | 5403 | 4338 | 4237 | 4295 | 4297 | 3615 |
| 251.2 | 3309 | 3980 | 3089 | 3069 | 3471 | 3535 | 3695 | 4036 | 3254 | 3196 | 3234 | 3185 | 2737 |
| 400.0 | 2469 | 2947 | 2314 | 2309 | 2579 | 2631 | 2736 | 2979 | 2411 | 2375 | 2408 | 2326 | 2053 |

| Shear | | | | | | | | | | | | |
|---|---|---|---|---|---|---|---|---|---|---|---|---|
| Rate | <−Sample number−> | | | | | | | | | | | |
| (1/s) | 14 | 15 | 16 | 17 | 18 | 19 | 20 | 21 | 22 | 23 | 24 | 25 |
| 1.0 | 25295 | 12234 | 29722 | 19941 | 37361 | 27812 | 35594 | 23300 | 38228 | 24781 | 31106 | 24637 |
| 1.6 | 22919 | 11336 | 26027 | 18218 | 32564 | 24661 | 31012 | 20973 | 33764 | 22329 | 26966 | 22105 |
| 2.5 | 20194 | 10463 | 22887 | 16381 | 27928 | 21797 | 27132 | 18846 | 29253 | 19944 | 23435 | 19706 |
| 4.0 | 17717 | 9561 | 19725 | 14652 | 23944 | 18977 | 23203 | 16626 | 24955 | 17513 | 20213 | 17297 |
| 6.3 | 15405 | 8627 | 16878 | 12875 | 20324 | 16367 | 19714 | 14508 | 21135 | 15200 | 17176 | 15017 |
| 10.0 | 13223 | 7663 | 14261 | 11157 | 17070 | 13894 | 16580 | 12467 | 17754 | 13041 | 14446 | 12839 |
| 15.8 | 11228 | 6712 | 11948 | 9519 | 14091 | 11673 | 13714 | 10584 | 14641 | 11031 | 12035 | 10849 |
| 25.1 | 9351 | 5773 | 9832 | 8012 | 11499 | 9622 | 11195 | 8802 | 11933 | 9162 | 9852 | 8981 |
| 39.8 | 7657 | 4891 | 7960 | 6598 | 9200 | 7787 | 8992 | 7193 | 9541 | 7462 | 7937 | 7306 |
| 63.1 | 6164 | 4047 | 6338 | 5329 | 7241 | 6195 | 7101 | 5771 | 7506 | 5974 | 6288 | 5839 |
| 100.0 | 4874 | 3286 | 4975 | 4230 | 5634 | 4847 | 5532 | 4551 | 5826 | 4698 | 4915 | 4587 |
| 158.5 | 3791 | 2621 | 3848 | 3304 | 4287 | 3734 | 4230 | 3533 | 4437 | 3637 | 3787 | 3550 |
| 251.2 | 2879 | 2044 | 2911 | 2526 | 3224 | 2807 | 3187 | 2673 | 3333 | 2747 | 2851 | 2678 |
| 400.0 | 2167 | 1561 | 2185 | 1894 | 2392 | 2091 | 2373 | 2003 | 2474 | 2056 | 2131 | 2002 |

TABLE 3

Ratio

| Sample | TCVR | MSE |
|---|---|---|
| No. | (%) | (%) |
| 1 | 93.7 | 55.5 |
| 2 | 96.3 | 212.3 |
| 3 | 92.2 | 18.2 |
| 4 | 91.3 | 5.6 |
| 5 | 95.6 | 87.6 |
| 6 | 94.0 | 73.0 |
| 7 | 95.0 | 115.4 |
| 8 | 95.9 | 189.6 |
| 9 | 94.7 | 80.4 |
| 10 | 92.8 | 30.2 |
| 11 | 93.7 | 51.0 |
| 12 | 93.1 | 33.2 |
| 13 | 91.9 | 0.0 |
| 14 | 91.4 | 0.2 |
| 15 | 87 | 0 |
| 16 | 93 | 143 |
| 17 | 91 | 63 |
| 18 | 94 | 205 |
| 19 | 92 | 127 |
| 20 | 93 | 191 |
| 21 | 91 | 90 |
| 22 | 94 | 212 |
| 23 | 92 | 103 |
| 24 | 93 | 154 |
| 25 | 92 | 101 |

As demonstrated in the above Table 3, the present invention unexpectedly achieved a large increase in melt strength (MSE) while maintaining a high level of shear-thinning (as evidenced by comparable TCVR) compared to that of the control. Particularly surprising was the marked improvement in melt strength achieved in samples 2, 7, 8, 16, 18, 19, 20, 22, 23, 24 and 25 versus the controls.

The foregoing description of various embodiments of the invention has been presented for purposes of illustration and description. It is not intended to be exhaustive or to limit the invention to the precise embodiments disclosed. Numerous modifications or variations are possible in light of the above teachings. The embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

1. A plasticized cellulose ester composition, said composition comprising at least one cellulose ester; at least one plasticizer; and an effective amount of a melt strength-enhancing additive selected from the group consisting of clay, silica and combinations thereof.

2. The composition of claim 1, wherein said composition comprises from 5% to 35% by weight of plasticizer based on the total weight of said composition.

3. The composition of claim 2, wherein said composition comprises from 10% to 30% by weight of plasticizer based on the total weight of said composition.

4. The composition of claim 1, wherein said plasticizer is selected from the group consisting of triethylene glycol 2-ethyl hexanoate, dioctyl adipate, di-n-hexyl azelate, epoxidized soybean oil, acetyl triethyl citrate and combinations thereof.

5. The composition of claim 1, wherein said amount of said melt-strength-enhancing additive is from 0.25% to 8.0% by weight based on the total weight of said composition.

6. The composition of claim 1, wherein the clay, wherein the clay has a particle size of from 1-60 microns, a density of 1.5-2.2 g/cm³, and a bulk density of less than 500 g/cm³.

7. The composition of claim 1, wherein said composition further comprises one or more of roll release agents, processing aids, impact modifiers, fillers such as calcium carbonate, flame retardants, lubricants, pigments, dispersing aids, biocides, antistatic agents, water repelling additives, rodenticides, dyes and colorants.

8. The composition of claim 1, wherein said at least one cellulose ester is selected from the group consisting of cellulose acetate propionate, cellulose acetate butyrate and combinations thereof.

9. The composition of claim 8, wherein said at least one cellulose ester is cellulose acetate propionate.

10. The composition of claim 1, wherein said composition exhibits a melt strength enhancement (MSE) of at least 20%.

11. A flooring article comprising at least one layer of the plasticized cellulose ester composition of claim 1.

12. A multilayer resilient flooring article that includes a core layer of the plasticized cellulose ester composition of claim 1.

13. A calendered article formed from the composition of claim 1.

14. The calendered article of claim 13, wherein said calendered article is a sheet or film.

15. The calendered article of claim 14, wherein said sheet or film is suitable for use as a layer of a multilayer resilient flooring article.

16. The plasticized cellulose ester composition of claim 1, wherein said plasticized cellulose ester composition exhibits a total complex viscosity reduction (TCVR) of at least 90%.
